(19) United States
(12) Patent Application Publication
(10) Pub. No.: US 2020/0262654 A1
(43) Pub. Date: Aug. 20, 2020

(54) Flight for Mesh Belt Conveyor Systems and Methods

(71) Applicant: Cambridge International, Inc., Cambridge, MD (US)

(72) Inventors: Logan Baxter, Laurel, DE (US); Brian Robinson, Hurlock, MD (US); Thomas Busch, Cambridge, MD (US); William Cannon, Cambridge, MD (US); Sean Lyons, Salisbury, MD (US)

(21) Appl. No.: 16/790,019

(22) Filed: Feb. 13, 2020

Related U.S. Application Data
(60) Provisional application No. 62/806,323, filed on Feb. 15, 2019.

(51) Int. Cl. B65G 19/24; B65G 19/00; B65G 15/48; B65G 15/54; B65G 17/42; B21D 22/02

(52) U.S. Cl. CPC B65G 19/24; B65G 19/00; B21D 22/02; B65G 15/54; B65G 17/42; B65G 15/48

(57) ABSTRACT

A flight for use in a mesh conveyor belt assembly that can have a first planar portion and a second planar portion extending non-coplanar to the first planar portion. The first planar portion can have a pair of tabs extending therefrom. Each tab can have a through-hole configured to receive a cross-rod of the mesh conveyor belt assembly therethrough.

### CROSS-REFERENCE TO RELATED APPLICATION

This application claims priority under 35 U.S.C. §119 to United States Provisional Patent Application No. 62/806,323 filed on Feb. 15, 2019, the entire contents of which are incorporated herein by reference.

### STATEMENT CONCERNING FEDERALLY SPONSORED RESEARCH AND DEVELOPMENT

Not applicable.

### TECHNICAL FIELD

The present disclosure is described in the context of woven metal mesh conveyor belt arrangements. More specifically, the present disclosure relates to woven mesh conveyor belt arrangements capable of use in incline/decline conveying applications incorporating a flight engaged with a cross-rod of a conveyor belt.

### BACKGROUND

Woven metal mesh belts are used in many different process conveying applications including, for instance, product freezing, frying, washing, chilling, and heat treatment. Varying the diameter of the wire used and changing the openings within the metal mesh allow the support surface provided by the woven metal belt to be adapted to the characteristics of an item being conveyed.

Frequently, woven metal mesh belts are used in incline/decline conveying applications or applications where the product needs to be confined within the length of the belt. For these applications, flights (a.k.a. “pushers”) may also be needed. However, it can be difficult to attach flights to the metal mesh in a way that is both practical and effective. The flights can be welded directly to the mesh at certain locations, but this can compromise the mesh itself and the welds can become prone to degradation during service due to loading and fatigue. Alternatively, flights can be attached to the mesh with “staples,” (i.e., short segments of wire fed from the underside of the mesh and then plug-welded to the flights to secure the flights to the belt surface). FIGS. 1 and 2 illustrate a flight secured to a mesh belt with staples. The staples are usually positioned to bridge a cross-rod and several wound wires of the wire mesh to provide further stability to the overall assembly. Although this method of assembly is effective, it is somewhat costly from a manufacturing standpoint and still requires welds on the belt carry surface that may be deemed unacceptable, such as in applications having specific sanitation standards.

Therefore, a need exists for an improved mesh conveyor belt system with flights that maintains the conventional features and benefits, while addressing various deficiencies associated with the assembly and implementation of flights on mesh conveyor belt assemblies.

### SUMMARY

Some embodiments provide a flight for use in a mesh conveyor belt assembly that can have a first planar portion and a second planar portion extending non-coplanar to the first planar portion. The first planar portion can have a pair of tabs extending therefrom, and each tab has a through-hole configured to receive a cross-rod of the metal mesh conveyor belt assembly therethrough.

Another embodiment includes a method of manufacturing a support system for coupling a flight to a mesh conveyor belt assembly. The method includes providing a flight with a first planar portion and a second planar portion extending non-coplanar to the first planar portion, forming a pair of holes into the first planar portion configured to receive a cross-rod of the mesh conveyor belt assembly, and forming a pair of tabs into the first planar portion whereby the pair of tabs contain the pair of holes.

In a further embodiment, a method for attaching a flight to a mesh conveyor belt assembly is provided. The method includes providing a mesh conveyor belt with at least one wound wire defining a passage, providing a cross-rod, providing a flight with a first planar portion and a second planar portion extending non-coplanar to the first planar portion, wherein the first planar portion has a pair of tabs extending therefrom, with each tab having a through-hole configured to receive a cross-rod of the mesh conveyor belt assembly therethrough, and inserting the cross-rod through the passage of the at least one wound wire and the through-holes of the flight to couple the mesh conveyor belt, the cross-rod, and the flight.

### BRIEF DESCRIPTION OF THE DRAWINGS

The following detailed description is to be read with reference to the figures, in which like elements in different figures have like reference numerals. The figures, which are not necessarily to scale, depict selected embodiments and are not intended to limit the scope of embodiments of the invention. Given the benefit of this disclosure, skilled artisans will recognize the examples provided herein have many useful alternatives that fall within the scope of the invention.

FIG. 1 is a top isometric view of related art showing a flight attached to a metal mesh belt with staples.

FIG. 2 is a bottom isometric view of the related art shown in FIG. 1.

FIG. 3 is a top isometric view of an example flight in accordance with one embodiment.

FIG. 4 is a top isometric view of the example flight with a cross-rod.

FIG. 5 is a top isometric view of the example flight installed on an example metal mesh belt.

FIG. 6 is a bottom isometric view of the example flight installed on the example metal mesh belt.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Given the benefit of this disclosure, various modifications to the illustrated embodiments will be readily apparent to those skilled in the art and the underlying principles herein can be applied to other embodiments and applications without departing from embodiments of the invention. Thus, embodiments of the invention are not intended to be limited to embodiments shown, but are to be accorded the widest scope consistent with the principles and features disclosed herein.

Some of the discussion below describes flights that can be attached to a metal mesh belt with a cross-rod of the metal mesh belt. The context and particulars of this discussion are presented as examples only. For instance, embodiments of the disclosed invention can be configured in various ways, including other shapes and arrangements of elements. Similarly, embodiments of the invention can be used with other types of conveyor belts or assemblies in addition to those expressly illustrated or described herein.

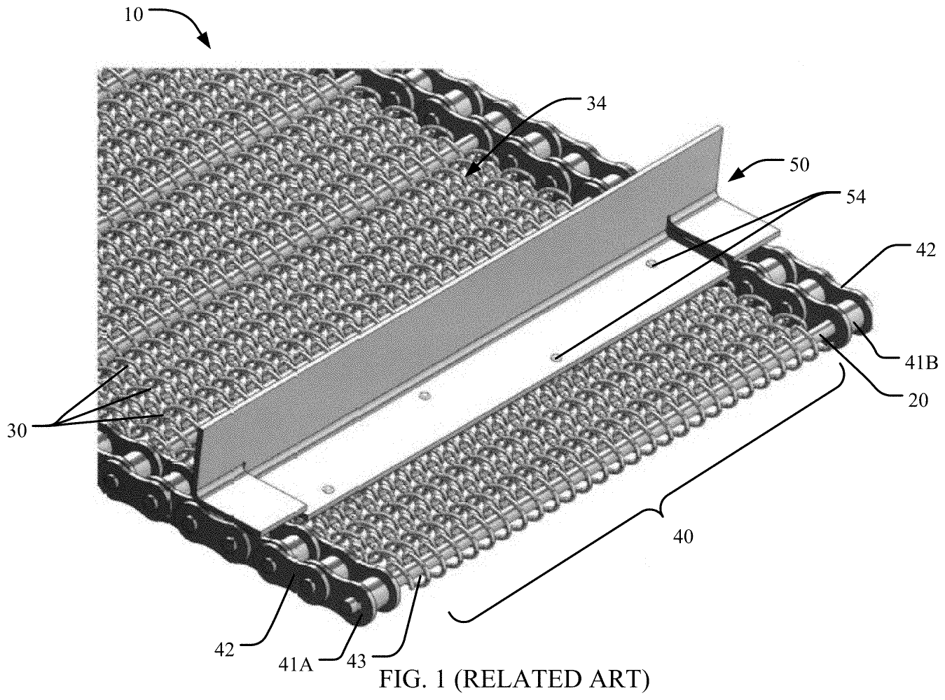

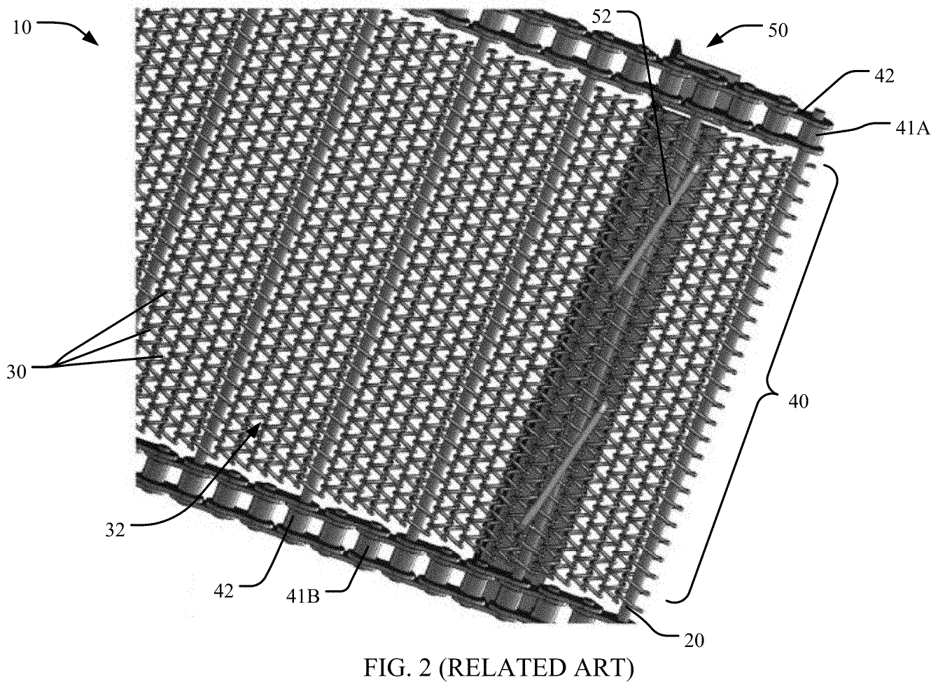

A metal mesh conveyor belt is typically an endless belt driven in a direction of travel. The mesh belt can be constructed to address particular application requirements, for example, the gauge of the wire used and the openings in the metal mesh can be changed depending on the type of item being conveyed. An example of a chain-driven mesh conveyor belt 10 is shown in FIGS. 1 and 2. The mesh conveyor belt 10 can generally be made from of a plurality of wound wires 30 interwoven to form a wire mesh 40 extending between lateral roller chains 42 that extend in the direction of travel. The wire mesh 40 can be attached to the roller chains by cross-rods 20 that extend from roller chain links 41A, through central passages 43 defined by the wound wires 30 of the wire mesh 40, and into opposing roller chain links 41B. The cross-rods can be spaced a predetermined distance apart in the direction of travel. As shown in FIG. 2, for example, the spacing or pitch of cross-rods 20 can be approximately every sixth wire 30 (i.e., a cross-rod 20 is inserted through the central passage 43 of every sixth wound wire 30).

A flight 50 attached to a metal mesh conveyor belt 10 with staples 52 is depicted in FIGS. 1 and 2 as an example of a way of attaching a flight to a mesh belt. The staples 52 are u-shaped wire segments that are fed from the underside 32 of the wire mesh 40 of the metal mesh conveyor belt 10 and through the topside 34 and secured to the flight 50 by plug-welding (as shown with plug-weld locations 54). The attachment of the flight 50 is therefore provided by a sandwiching of the wire mesh 40 between the staples 52 and the flight 50, and is dependent on the welds remaining intact.

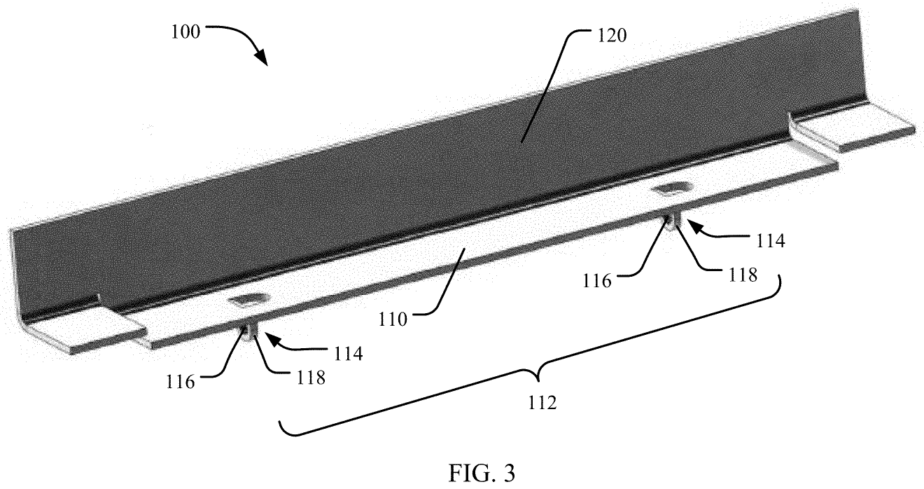

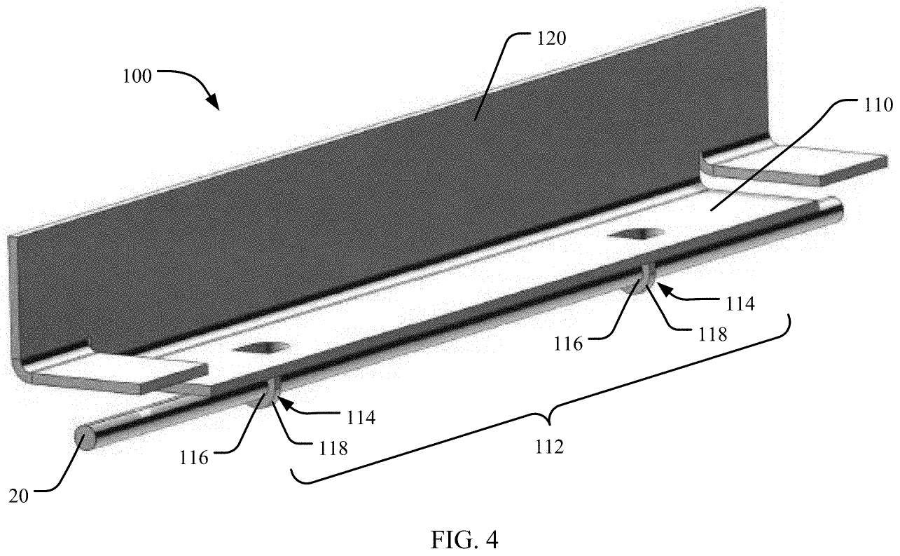

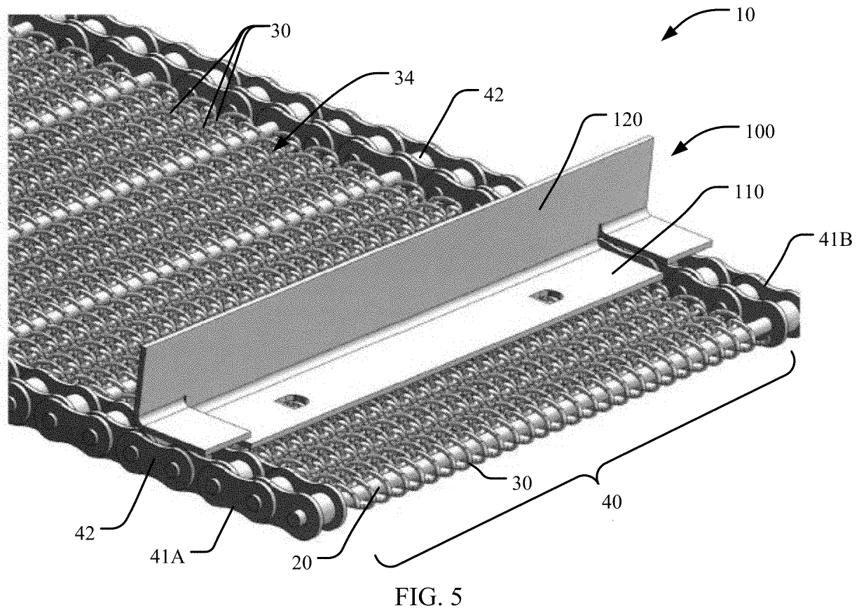

An example of a flight 100 according to one embodiment is shown in FIGS. 3 and 4. The flight 100 has first planar member 110 and a second planar member 120 positioned substantially perpendicular to the first planar member 110. The relative orientation of the first planar member 110 and the second planar member 120 is application specific, and can define a generally non-coplanar relationship. The contours, sizes, and features of the flights 100 can also be application specific to accommodate the object being conveyed or other desired engagement characteristics. The first planar member 110 is configured to be placed in contact with the top side 34 of the wire mesh 40 (see FIG. 5) of the mesh conveyor belt 10. The flight 100 includes a support system 112 configured to couple the flight 100 to the mesh conveyor belt 10. The example support system 112 has a pair of tabs 114 depending from the first planar member 110 in the same direction, and each of the tabs 114 has a through-hole 116 and a periphery 118. The through-holes 116 are sized and configured to receive the cross-rod 20 therethrough.

The pair of tabs 114 can be formed by stamping the first planar member 110 and can be sized and configured based on the specifications of the mesh conveyor belt 10 (e.g., so as to nest between consecutive windings of a wound wire 30). Considerations may be given to, for instance, the diameter of the cross-rod 20, the distance between the cross-rod 20 and the top side 34 of the mesh 40, and the lateral spacing defined by the wound wires 30. Further, it should be understood that more or fewer tabs 114 may be provided on the flight 100 yet remain within the purview of the inventive concept. For example, more or fewer tabs 114 may be provided depending on the width of the mesh belt or depending on the characteristics of the item being conveyed.

A method for forming a tab 114 can include punching the through-hole 116 of the tab 114 in the first planar member 110, punching and forming the periphery 118 of the tab 114 around the location of the through-hole 116, and bending the tab 114 substantially perpendicular to the first planar member 110 and in the direction opposite the second planar member 120. This process provides a tab 114 that is integrally formed with the flight 100; however, other configurations are contemplated, including attaching separate tabs to the first planar member 110 through welding or other fastening means. Other methods are also available to establish the desired structure of the tabs 114, such as waterjet or laser cutting.

The periphery 118 of the tab 114 preferably has an arcuate profile as shown. The arcuate profile provides a rounded surface facing the direction of travel (and the underside 32 of the mesh 40) thereby reducing the likelihood of catching on any obstructions present beneath the mesh conveyor belt 10. The arcuate profile also reduces the number of stress risers created in the first planar member 110 when the tab 114 is punched. For example, a square tab profile would create at least two stress riser corners in the negative area created by a punched tab. That being said, however, the arcuate profile should not be viewed as limiting as other profiles are contemplated.

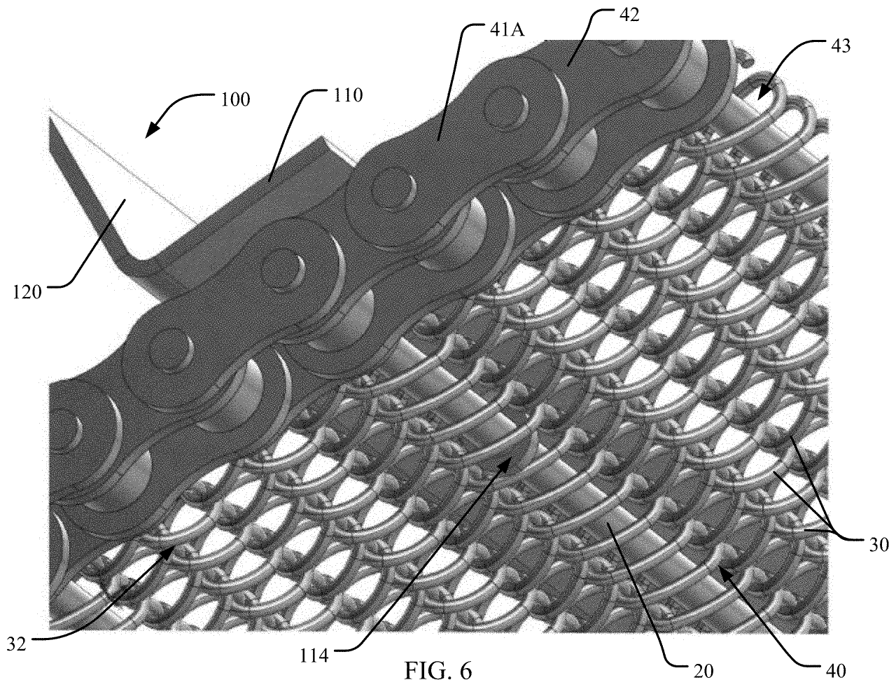

FIGS. 5 and 6 illustrate the flight 100 attached to the mesh conveyor belt 10. During construction and assembly of the mesh conveyor belt 10, adjacent wound wires 30 are interwoven and the cross-rod 20 extends through the central passage 43 of a wound wire 30 to establish the desired pitch. The cross-rod 20 is secured between the opposing roller chains 42, such as by oversized or deformed head ends of the cross-rod. The flight 100 is located at a preferred location of the wire mesh 40 with the pair of tabs 114 extending into the central passage 43 defined by the particular wound wire 30 in which the cross-rod 20 is to be provided, and the through-holes 116 are located generally coaxially with the central passage 43. As depicted, the cross-rod 20 is fed through the pair of tabs 114 of the flight 100 as it is fed through the central passage 43 of the wound wire 30. Therefore, the flight 100 is attached to the mesh conveyor belt 10 during the assembly of the mesh conveyor belt 10 when the cross-rod 20 is captured within the wound wire 30.

It will be appreciated by those skilled in the art that while the invention has been described above in connection with particular embodiments and examples, the invention is not necessarily so limited, and that numerous other embodiments, examples, uses, modifications, and departures from the embodiments, examples, and uses are intended to be encompassed by the claims attached hereto. For example, the spacing, size, gauge, form-factor, and other features may vary based on application-specific requirements (e.g., product to be conveyed, environmental factors, speed of conveyance, operational envelope limitations, etc.). In addition, while the embodiments have been described in context of a metallic construction, it is contemplated that other materials (e.g., polymers) or composite constructions (e.g., a metallic base with a plastic overmold) are possible. A mesh belt incorporating the attachment of a flight with integrally formed tabs during assembly establishes a mesh conveyor with fewer individual components that is more efficiently produced, manufactured, and assembled. Other types of conveyor belts may also benefit from the incorporation of aspects of the invention. The entire disclosure of each patent and publication cited herein is incorporated by reference, as if each such patent or publication were individually incorporated by reference herein.

Various features and advantages of the invention are set forth in the following claims.

1. A flight for use in a mesh conveyor belt assembly comprising:
a first planar portion; and
a second planar portion extending non-coplanar to the first planar portion;
the first planar portion having a pair of tabs extending therefrom, each tab with a through-hole configured to receive a cross-rod of the mesh conveyor belt assembly therethrough.

2. The flight of claim 1, wherein the pair of tabs are integrally formed from the first planar portion.

3. The flight of claim 1, wherein the pair of tabs have an arcuate periphery.

4. The flight of claim 1, wherein the pair of tabs extend in a direction opposite the second planar portion.

5. The flight of claim 4, wherein the direction is directly opposite the second planar portion.

6. The flight of claim 1, wherein the pair of tabs extend in a same direction.

7. The flight of claim 6, wherein the same direction is opposite the second planar portion.

8. The flight of claim 1, wherein the second planar portion extends substantially perpendicular to the first planar portion.

9. A method of manufacturing a support system for coupling a flight to a mesh conveyor belt assembly, the method comprising:
providing a flight with a first planar portion and a second planar portion extending non-coplanar to the first planar portion;
forming a pair of holes into the first planar portion configured to receive a cross-rod of the mesh conveyor belt assembly; and
forming a pair of tabs into the first planar portion, the pair of tabs containing the pair of holes.

10. The method of claim 9, wherein the step of forming the pair of tabs comprises forming the pair of tabs in a same direction and opposite the second planar portion.

11. The method of claim 10, wherein the step of forming the pair of tabs in the same direction and opposite the second planar portion comprises bending the pair of tabs.

12. The method of claim 9, wherein the pair of tabs are formed with an arcuate periphery.

13. The method of claim 9, wherein the steps of forming the pair of holes into the first planar portion and forming the pair of tabs into the first planar portion occur substantially simultaneously.

14. The method of claim 9, wherein:
the step of forming the pair of holes into the first planar portion configured to receive the cross-rod of the mesh conveyor belt assembly comprises punching the pair of holes; and
the step of forming the pair of tabs into the first planar portion comprises punching the pair of tabs.

15. A method for attaching a flight to a mesh conveyor belt assembly, the method comprising:
providing a mesh conveyor belt comprising at least one wound wire defining a passage;
providing a cross-rod;
providing a flight with a first planar portion and a second planar portion extending non-coplanar to the first planar portion, wherein the first planar portion has a pair of tabs extending therefrom, and each tab has a through-hole configured to receive a cross-rod of the mesh conveyor belt assembly therethrough; and
inserting the cross-rod through the passage of the at least one wound wire and the through-holes of the flight to couple the mesh conveyor belt, the cross-rod, and the flight.
